(19) United States
(12) Patent Application Publication
(10) Pub. No.: US 2021/0245451 A1
(43) Pub. Date: Aug. 12, 2021

(54) TAPE LAMINATION HEAD

(71) Applicant: Fives Machining Systems, Inc., Fond du Lac, WI (US)

(72) Inventors: Nicholas Boroughs, Seattle, WA (US); Duncan Kochhar-Lindgren, Seattle, WA (US); Cody Casteneda, Kent, WA (US); Nicholas Gacek, Seatec, WA (US); Amanda Kotchon, Seattle, WA (US)

(21) Appl. No.: 17/029,277

(22) Filed: Sep. 23, 2020

Related U.S. Application Data
(60) Provisional application No. 62/971,018, filed on Feb. 6, 2020.

(51) Int. Cl. B29C 70/38

(52) U.S. Cl. CPC B29C 70/388; B29K 2307/04

(57) ABSTRACT

A tape lamination head for applying composite tape onto a mold or mandrel amid the formation of a composite workpiece. The tape lamination head is but one component of a larger tape lamination machine and assembly. Among its components, the tape lamination head includes a tape supply reel and multiple rollers. The tape supply reel receives a tape supply spool. The rollers carry composite tape from the tape supply spool downstream of the tape supply reel. The composite tape is carried by the rollers about a composite tape path that is defined by the tape lamination head. At a location along the composite tape path, one or more of the rollers situates the composite tape so that a backing paper side of the composite tape ends up in confrontation with a layup surface upon which the composite tape is applied.

### CROSS-REFERENCE TO RELATED PATENT APPLICATION

This is a U.S. Non-provisional patent application claiming the benefit of priority from U.S. Provisional patent application number 62/971,018 filed on Feb. 6, 2020, the entire contents of which are incorporated herein.

### TECHNICAL FIELD

The present application relates to tape lamination machines and, more particularly, to tape lamination heads equipped in tape lamination machines for applying composite tape on molds or mandrels amid the formation of composite workpieces.

### BACKGROUND

Tape lamination machines are used in the production of composite workpieces. The machines are employed in aerospace applications for aerospace parts, as well as in other applications for other parts. Composite material, in the form of fibrous material impregnated with resin, is applied by the machines to a mold or mandrel at precise locations and lengths to collectively form a composite workpiece. The tape lamination machine moves a tape lamination head over the mold to precisely apply composite tape in the ultimate shape of the composite workpiece. As the tape lamination head moves, it leaves a plurality of composite tape segments, also referred to as a course, behind on the mold. The automatic application of these composite tape segments to the mold involves the cooperation of a diverse collection of machinery that holds, moves, and ultimately cuts the composite tape.

The composite tape is typically wound in a spool arrangement and loaded into the tape lamination head. The composite tape has a backing paper on its bottom side of winding to avoid tape-on-tape adhesion. When unwound from the spool and routed through the tape lamination head during use, a top side of the composite tape lacking the backing paper (also called a sticky or tacky side) is applied facedown to the mold and brought in direct contact with the mold. The routing of the composite tape through the tape lamination head is hence designed to ensure that the composite tape's bottom side with the backing paper faces upward and outward as the composite tape is exiting the tape lamination head and once it is applied to the mold.

### SUMMARY

In one implementation, a tape lamination head may include a tape supply reel and multiple rollers. The tape supply reel receives a tape supply spool. The rollers carry composite tape of the tape supply spool downstream of the tape supply reel. The composite tape is carried about a composite tape path defined at the tape lamination head. At a location along the composite tape path, one or more of the rollers situates the composite tape such that a backing paper side of the composite tape is brought to confront a layup surface before the composite tape is applied to the layup surface.

In another implementation, a tape lamination head may include a tape supply reel, multiple rollers, and a compactor. The tape supply reel receives a tape supply spool. The rollers carry composite tape of the tape supply spool downstream of the tape supply reel. The compactor is located near an exit of the tape lamination head and can come in the form of a compaction roller or can take another form. During use of the tape lamination head, backing paper carried by the composite tape is removed from the composite tape at a location that is upstream of the compactor. A backing paper side of the composite tape exhibits a facedown orientation at the exit of the tape lamination head.

In yet another implementation, a tape lamination head may include a tape supply reel, multiple rollers, and a compactor. The tape supply reel receives a tape supply spool. The rollers carry composite tape of the tape supply spool downstream of the tape supply reel. The composite tape is carried about a composite tape path defined at the tape lamination head. The compactor is located near an exit of the tape lamination head and can come in the form of a compaction roller or can take another form. At a first location along the composite tape path, one or more of the rollers situates the composite tape such that a backing paper side of the composite tape would be brought to confront a layup surface before the composite tape is applied to the layup surface. At a second location along the composite tape path, backing paper carried by the composite tape is removed from the composite tape.

### BRIEF DESCRIPTION OF THE DRAWINGS

FIG. 1 is a perspective view depicting an implementation of a tape lamination machine and assembly;

FIG. 2 is a perspective view depicting an implementation of a tape lamination head that can be equipped in the tape lamination machine and assembly;

FIG. 3 is a side view of the tape lamination head demonstrating a composite tape path;

FIG. 4 is an enlarged view of a region of the tape lamination head intended to show removal of backing paper from composite tape; and

FIG. 5 is an enlarged view of another region of the tape lamination head illustrating a backing paper path after its removal from composite tape.

### DETAILED DESCRIPTION

The figures present an embodiment of a tape lamination head 10 that is equipped in a larger tape lamination machine and assembly 12. Unlike past tape lamination heads, the tape lamination head 10 applies composite tape 14 to an underlying mold or mandrel in a manner in which a backing paper side 16 of the composite tape 14 is ultimately brought facedown to the mold. A composite tape path 18 about which the composite tape 14 is routed through the tape lamination head 10 is hence dissimilar and, in the embodiment presented by the figures, generally inverse that of past tape lamination heads. A greater tape effectiveness and enhanced tape-to-tape consistency is provided with use of the tape lamination head 10 and, in some instances, a reduced need for added heat to effect lamination results. These, as well as other enhancements, are described below in more detail. Furthermore, as used herein, the terms downstream and upstream are used with respect to the direction of composite tape movement at the tape lamination head such that downstream refers to a direction that is with the direction of movement and upstream refers to a direction that is against the direction of movement.

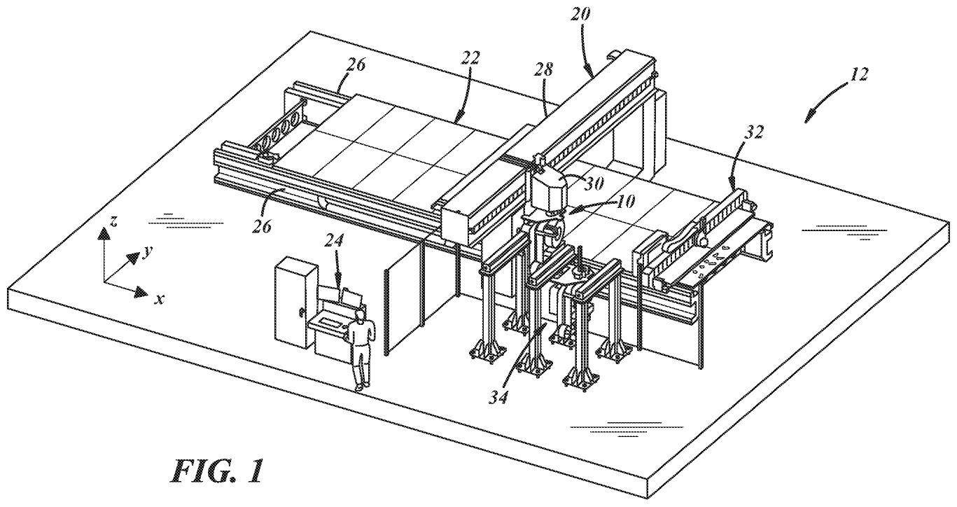

With reference to FIG. 1, the tape lamination machine and assembly 12 is used to prepare composite workpieces by applying the composite tape 14 to molds. The aerospace industry employs the machines and assemblies for aerospace workpieces such as long narrow flat parts, nested multi-part laminates, drape-formed skins, spars, stringers, beams, flaps, shear ties, ply packs, wing and tail skins, and many other parts. Still, the machines and assemblies are suitable for use in other industries and for other parts. The tape lamination machine and assembly 12 can have various layouts, setups, and equipment depending upon the particular application and particular part it is used to prepare. In the implementation of FIG. 1, the tape lamination machine and assembly 12 generally includes a gantry 20, a vacuum table 22, and an operator station 24. The tape lamination head 10 is docked to the gantry 20, and the gantry 20 provides certain movements of the tape lamination head 10 during the application of the composite tape 14. X-axis movement is carried out via a pair of longitudinal ways 26 and, by way of example, can be effected by rack and pinion drive units. Y-axis movement is carried out via a cross saddle 28 and, by way of example, can be effected by a linear motor and permanent magnets. Z-axis movement is carried out via a vertical slide 30 and, by way of example, can be effected by a precision ball screw actuator with a gearbox and a servo motor. The vertical slide 30 can also provide C-axis rotational movement which, by way of example, can be effected by a servo motor and a gearbox. Still, the tape lamination head 10 can be carried by other equipment and its movement can be provided in other ways; for example, the tape lamination head 10 could be mounted to a robotic arm that manipulates its movement in a different manner than described above.

Still referring to FIG. 1, the vacuum table 22 holds the mold (not shown) while the mold undergoes application of the composite tape 14 from the tape lamination head 10. The operator station 24 can serve as a human-to-machine interface (HMI) site and permits operator control and management of the tape lamination machine and assembly 12. Furthermore, and as shown in FIG. 1, the tape lamination machine and assembly 12 can include an auxiliary gantry 32 with trimming capabilities for parts, and can include a secondary tape lamination head and exchange station 34 for replacing tape lamination heads at the gantry 20 in need of composite tape supply or for other reasons. While shown and described with these layouts, setups, and equipment, the tape lamination machine and assembly 12 can have more, less, and/or different layouts, setups, and/or equipment in other implementations.

The precise nature of the composite tape 14 laid down by the tape lamination head 10 will depend on the particular application and part. In the aerospace example, the composite tape 14 can be in the form of a unidirectional carbon fiber tape impregnated with thermoset or thermoplastic resin and having a carrier or backing paper 36 on one of the two sides of the composite tape 14. The edge-to-edge width of the composite tape 14 can vary—again depending on application and part—and in the aerospace example could be fifty millimeters (50 mm), seventy-five millimeters (75 mm), one hundred and fifty millimeters (150 mm), or three hundred millimeters (300 mm); still, other width dimensions are possible. Prior to its loading in the tape lamination head 10, the composite tape 14 is wound on a tape supply spool 38 in an arrangement with a sticky or tacky side 40 of the composite tape 14 facing radially-outwardly and with the backing paper side 16 of the composite tape 14 facing radially-inwardly.

Amid pauses between composite tape application procedures, as well as at other times, composite tape can remain static within tape lamination heads. A length and extent of the static composite tape held taut by rollers can consequently remain exposed to the ambient environment and atmosphere for certain periods of time. It has been found that over such time periods the exposed sticky side of the composite tape that lacks the protection of backing paper can degrade. The sticky side can lose tackiness, can become dry, or can experience other unwanted conditions. In the past, the degraded extent of composite tape has hindered the effectiveness of adhesion of the composite tape when its sticky side is initially laid facedown on a mold and when it is subsequently applied facedown to previously laid tape. Due to the less effective adhesion, increased heat for lamination has often been required.

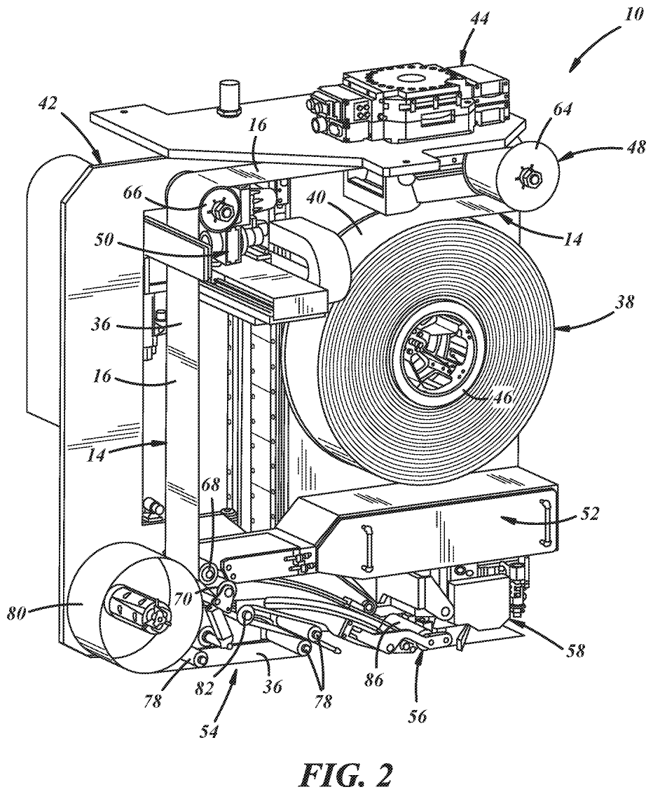

The tape lamination head 10 presented by the figures resolves the shortcomings of these past tape lamination heads. The tape lamination head 10 applies the composite tape 14 with the backing paper side 16 brought facedown to the mold, instead of the sticky side 40 being brought facedown as in previous application procedures. The backing paper side 16 directly confronts and opposes a layup surface 62 of the underlying mold upon exit of the composite tape 14 from the tape lamination head 10. It is therefore the backing paper side 16 that is laid down and applied to the layup surface 62, rather than the sticky side 40. The backing paper side 16 is protected by the backing paper 36 from the ambient environment and atmosphere even when the composite tape 14 is static and, as a result, unwanted degradation is avoided and adhesion effectiveness is maintained. Greater consistency of adhesion among composite tape segments is therefore achieved with use of the tape lamination head 10, and the need for increased heat to effect lamination may be averted. The tape lamination head 10 can have various designs, constructions, and components depending upon the particular application it is intended for use with and the particular parts it is intended to prepare. In the embodiment of FIGS. 2-5, the tape lamination head 10 generally includes a frame 42, a coupler 44, a tape supply reel 46, a set of rollers 48, a cutter 50, a scrap collector 52, a backing paper removal assembly 54, a compactor 56, and an inspection device 58. Still, in other embodiments the tape lamination head 10 can have more, less, and/or different components than those set forth here.

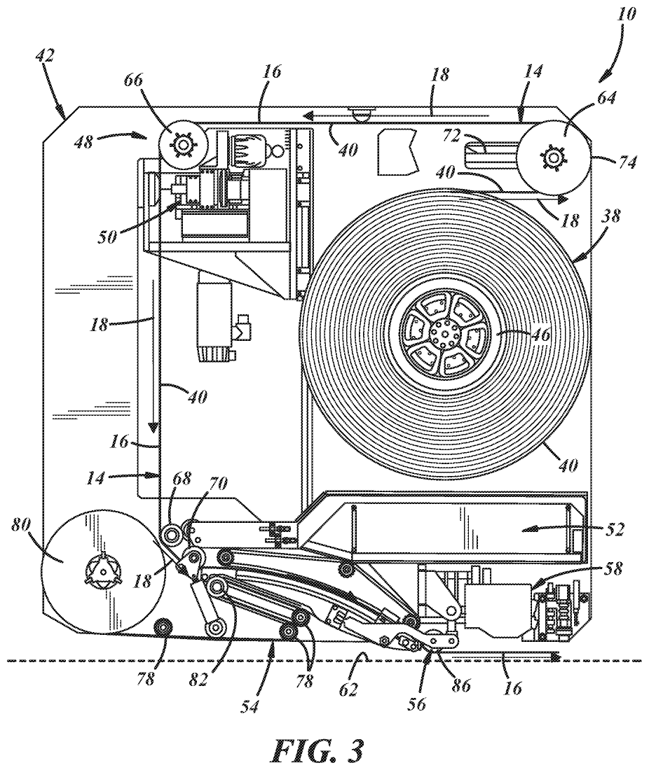

With particular reference to FIGS. 2 and 3, the frame 42 serves as the main structure of the tape lamination head 10 to which other components are mounted and about which other components are arranged. The frame 42 could form an enclosed housing, or can be an open-sided structure as illustrated in the figures. The coupler 44 provides a docking interface for attachment and detachment of the tape lamination head 10 to and from the gantry 20. The tape supply reel 46 receives the tape supply spool 38 for loading the tape supply spool 38 and its wound composite tape 14 in the tape lamination head 10. The tape supply reel 46 can be driven to rotate via a servo motor in order to unwind composite tape 14 from the tape supply spool 38 and feed the composite tape 14 through the tape lamination head 10 for downstream usage. The cutter 50 severs the composite tape 14 during use of the tape lamination head 10 in order to produce terminal ends of composite tape segments as needed for the particular mold. The scrap collector 52 gathers scrap pieces of the composite tape 14 resulting from cutting of the composite tape 14. The scrap collector 52 can include a bin for containing the scrap pieces. The inspection device 58 detects lap and gap tolerances of the composite tape 14 as it is laid down on the underlying mold.

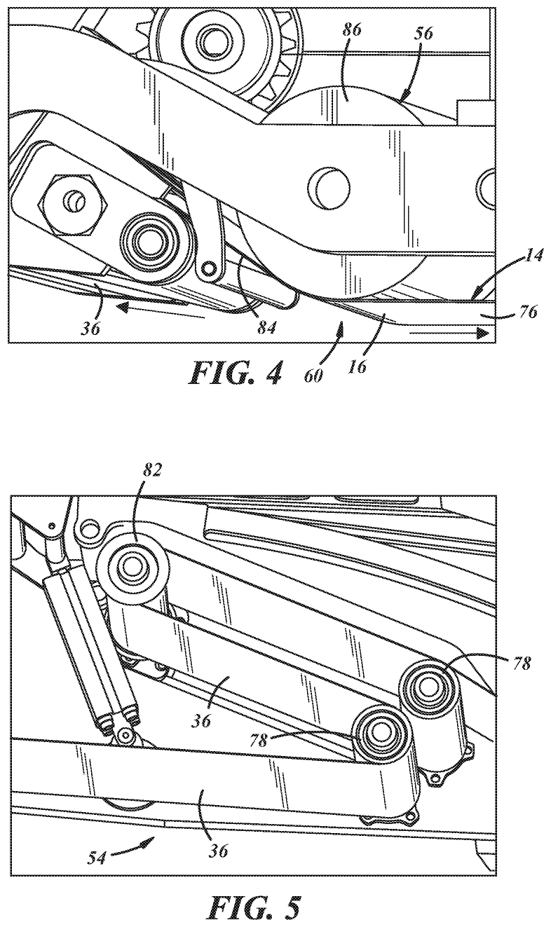

The rollers 48 assist with carrying the composite tape 14 from the tape supply spool 38 and downstream of the tape supply reel 46. The composite tape 14 is routed internally through the tape lamination head 10 to an exit 60 (FIG. 4) via the rollers 48 for application to the layup surface 62 of the underlying mold. Along the way, the composite tape 14 can be carried and supported by other components apart from the rollers 48. The rollers 48 can have different arrangements and can come in differing quantities. In the embodiment of FIGS. 2 and 3, the rollers 48 include a first roller 64, a second roller 66, a third roller 68, and a fourth roller 70. The first roller 64 resides immediately downstream of the tape supply spool 38 and is the initial roller of the set of rollers 48 to accept engagement from the composite tape 14 as the composite tape 14 comes off of the tape supply spool 38. Here, the first roller 64 is in the form of a dancer roller that functions to maintain tension and tautness of the composite tape 14 as the composite tape 14 is routed through the tape lamination head 10 and as the tape supply spool 38 is depleted of composite tape. In this regard, the first roller 64 is moveable forward and backward along a linear guide 72. The second roller 66 resides downstream of the first roller 64, and the third and fourth rollers 68, 70 reside downstream of the second roller 66.

The precise routing of the composite tape 14 through the tape lamination head 10 is set by the location of the rollers 48 and defines the composite tape path 18. The composite tape path 18 is schematically represented in FIG. 3 by numerous arrowed lines residing alongside the composite tape 14 along its taut extent from the tape supply spool 38, over the rollers 48, and to the exit 60. In the embodiment of FIG. 3, the composite tape path 18 routes the composite tape 14 in a manner which is reverse that of past tape lamination heads. The reversal works to bring the backing paper side 16 of the composite tape 14 to its facedown orientation and confrontation with the layup surface 62. The reversal can be carried out in various ways in different embodiments. In this embodiment, the direction of movement of the composite tape 14 as it initially comes off of the tape supply spool 38 is turned in an opposite direction by the first roller 64. The first roller 64 redirects the composite tape 14 one-hundred-and-eighty degrees (180°) from its previous direction in the example here; other changes of direction are possible in other examples. This occurs at a first location 74 along the composite tape path 18 that is immediately downstream of the tape supply spool 38 and prior to the composite tape 14 coming into engagement with downstream rollers. Still, in other embodiments the reversal could occur at other locations along the composite tape path 18 and by way of other rollers. In the embodiment of the figures, because of the reversed routing of the composite tape 14, the sticky side 40 makes surface-to-surface abutment with exterior surfaces of the rollers 64, 66, 68, 70 as the composite tape 14 travels over the rollers.

The backing paper removal assembly 54 separates and peels the backing paper 36 from the tape main body of the composite tape 14. Referring now to FIG. 4, the separation occurs at a second location 84 along the composite tape path 18. The second location 84 resides downstream of the first location 74 and downstream of all of the rollers 48. Further, the second location 84 is immediately upstream of the compactor 56 and immediately upstream of the exit 60. Once separated, a second sticky side 76 is revealed and ready for surface-to-surface application to the layup surface 62. In the embodiment of the figures, and referring now to FIGS. 2 and 3 and 5, the backing paper removal assembly 54 includes a set of rollers 78 and a backing paper take-up reel 80. The rollers 78 assist with carrying the backing paper 36 once the backing paper 36 is separated from the tape main body. With particular reference to FIG. 5, the rollers 78 include multiple rollers positioned downstream and upstream one another, one of which is in the form of a dancer roller 82 that functions to maintain tension and tautness of the backing paper 36 as the backing paper 36 is pulled from the tape main body and fed to the backing paper take-up reel 80. The backing paper take-up reel 80 accumulates the backing paper 36 and winds the backing paper 36 fed to it downstream of the rollers 78. The backing paper take-up reel 80 can be driven to rotate via a servo motor in order to take-up the peeled-off backing paper 36.

The compactor 56 exerts compaction pressure and load to the tape main body of the composite tape 14 as the tape main body is being applied to the layup surface 62. The compactor 56 can have various designs, constructions, and components in different embodiments. In this embodiment, and referring to FIGS. 2 and 3 and 4, the compactor 56 is in the form of a compaction roller 86. The compaction roller 86 is mounted at or near the exit 60 so that the compaction roller 86 can come into abutment with the tape main body as the tape main body is dispensed through the exit 60. In the example of the figures, the compaction roller 86 is a single, soft polyurethane compaction roller. Since the backing paper 36 is removed from the tape main body of the composite tape 14 upstream of the compaction roller 86, the compaction effect on the tape main body is enhanced when application of the tape main body encounters plane transitions in the layup surface 62 such as ramps, padups, and certain contours.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A tape lamination head, comprising:
a tape supply reel for receipt of a tape supply spool; and
a plurality of rollers for carrying composite tape of the tape supply spool downstream of the tape supply reel and about a composite tape path defined at the tape lamination head;
wherein, at a location along the composite tape path, at least one of the plurality of rollers situates the composite tape such that a backing paper side of the composite tape is in confrontation with a layup surface prior to application of the composite tape to the layup surface.

2. The tape lamination head as set forth in claim 1, further comprising a compaction roller and a backing paper take-up reel, and wherein, amid use of the tape lamination head, backing paper is removed from the composite tape and fed to the backing paper take-up reel, and the removal of the backing paper occurs at a second location along the composite tape path upstream of the compaction roller.

3. The tape lamination head as set forth in claim 1, wherein the at least one of the plurality of rollers is a first roller initially carrying the composite tape downstream of the tape supply reel and effecting reversal of direction of the composite tape path.

4. The tape lamination head as set forth in claim 1, wherein, amid use of the tape lamination head, a sticky side of the composite tape makes abutment with an exterior surface of the at least one of the plurality of rollers.

5. A tape lamination machine and assembly comprising the tape lamination head of claim 1.

6. A tape lamination head, comprising:
a tape supply reel for receipt of a tape supply spool;
a plurality of rollers for carrying composite tape of the tape supply spool downstream of the tape supply reel; and
a compactor located adjacent an exit of the tape lamination head;
wherein, amid use of the tape lamination head, backing paper is removed from the composite tape at a location upstream of the compactor and a backing paper side of the composite tape has a facedown orientation at the exit of the tape lamination head.

7. The tape lamination head as set forth in claim 6, wherein at least one of the plurality of rollers situates the composite tape such that the backing paper side of the composite tape has the facedown orientation at the exit of the tape lamination head.

8. The tape lamination head as set forth in claim 7, wherein the at least one of the plurality of rollers resides downstream of the tape supply reel and initially carries the composite tape downstream of the tape supply reel prior to the carrying of the composite tape by the other of the plurality of rollers.

9. The tape lamination head as set forth in claim 6, wherein at least one of the plurality of rollers effects a change of direction of the composite tape over a composite tape path, the change of direction bringing the backing paper side of the composite tape to have the facedown orientation at the exit of the tape lamination head.

10. The tape lamination head as set forth in claim 6, wherein the compactor is a compaction roller.

11. The tape lamination head as set forth in claim 6, wherein removal of the backing paper from the composite tape occurs immediately upstream of the compactor and downstream of all of the plurality of rollers.

12. A tape lamination head, comprising:
a tape supply reel for receipt of a tape supply spool;
a plurality of rollers for carrying composite tape of the tape supply spool downstream of the tape supply reel and about a composite tape path defined at the tape lamination head; and
a compactor located adjacent an exit of the tape lamination head;
wherein, at a first location along the composite tape path, at least one of the plurality of rollers situates the composite tape such that a backing paper side of the composite tape would be in confrontation with a layup surface prior to application of the composite tape to the layup surface;
wherein, at a second location along the composite tape path, backing paper is removed from the composite tape.

13. The tape lamination head as set forth in claim 12, wherein the first location is upstream of the second location.

14. The tape lamination head as set forth in claim 12, wherein the first location is immediately downstream of the tape supply reel and the at least one of the plurality of rollers initially carries the composite tape downstream of the tape supply reel prior to the carrying of the composite tape by the other of the plurality of rollers.

15. The tape lamination head as set forth in claim 12, wherein the second location is immediately upstream of the compactor and downstream of all of the plurality of rollers.
